(19) United States
(12) Patent Application Publication
(10) Pub. No.: US 2014/0189346 A1
(43) Pub. Date: Jul. 3, 2014

(54) LICENSE SERVER MANAGER

(71) Applicant: NEXT EDUCATION, LLC, Emeryville, CA (US)

(72) Inventor: Kevin CURETON, San Francisco, CA (US)

(21) Appl. No.: 14/099,843

(22) Filed: Dec. 6, 2013

Related U.S. Application Data
(60) Provisional application No. 61/746,894, filed on Dec. 28, 2012.

(51) Int. Cl. G06F 21/10; H04L 29/06

(52) U.S. Cl. CPC G06F 21/105; H04L 63/083
USPC 713/155

(57) ABSTRACT

Technology is disclosed for managing provision of licenses in an unsecure communication network (“the technology”). Various embodiments of the technology include creating a secure communication tunnel between a client device of a user requesting a license and a license server that contains the license for a secure transmission of the license from the license server to the client device. After a first successful authentication of the user, the license management server generates and sends temporary credentials to the client device. The client device uses the temporary credentials to setup the secure communication tunnel with the license management server that will be used to access the license server. The client device sends the request to the license server over the secure communication tunnel, which in response transmits the license back to the client device over the secure communication tunnel.

### CROSS-REFERENCE TO RELATED APPLICATION(S)

This application claims to the benefit of U.S. Provisional Patent Application No. 61/746,894, entitled “LICENSE SERVER MANAGER”, which was filed on Dec. 28, 2012, which is incorporated by reference herein in its entirety.

### TECHNICAL FIELD

Several of the disclosed embodiments relate to management of provision of licenses for electronic content, and more particularly, to management of provision of licenses using a secure communication protocol.

### BACKGROUND

Certain electronic content, including software applications, music, movies, images, etc. may require a user to have a license to access them. The license can be of various types, e.g., for a single use, for a certain period, to buy etc. A user who is authorized to use the license may be identified in various ways. For example, the user may be required to create a user account at a license server. The user may be authenticated using a username and password the user used to create the user account and then be provided with the license to access the content.

License servers may be used to manage provision of licenses to users requiring access to a particular content. For example, a license server may provide a license to employees in an organization for accessing a particular application. The license server may determine whether a particular employee is authorized to use the license using a username and password of the user. The authentication mechanisms provided by the license server may be adequate in a protected environment such as a local area network of the organization. However, such license servers are not secure enough, especially when exposed to a unsecure and public network such as Internet. Such license servers may be prone to security breaches. One possible way to improve their security is to make the license server accessible over a virtual private network (VPN) of the organization. However, such a solution is not scalable when there are a number of license servers. Further, such a solution does not provide a way to balance the load between the license servers when many users connect to a same license server. Thus, the current license management techniques are inefficient.

### SUMMARY

Technology is disclosed for managing provision of licenses in an unsecure communication network (“the technology”). Various embodiments of the technology include creating a secure environment to serve license requests from users in an unsecure environment such as Internet. One such embodiment includes a license management server that creates a secure communication tunnel, such as secure shell (SSH) tunnel, between a client device of a user requesting a license and a license server that contains the license for accessing a particular application. In some embodiments, the client device can communicate with the license management server and/or a license server over a communication network such as Internet.

In some embodiments, the license management server provides an application programming interface (API) for management of licenses. The API can be accessible via an encrypted communication channel such as hypertext transfer protocol secure (HTTPS). The user can use the API to request the license management server to obtain the license. In some embodiments, the license management server performs multiple authentications to ensure that the user requesting the license is authorized to use the license. Upon receiving a request for a license of a particular type from the user, the license management server checks if the user is authorized to use the license, and if the user is authorized, it sends back set of temporary credentials to the client device that specifies how to setup the SSH tunnel that will be used to access the license server.

In some embodiments, the set of temporary credentials can include a temporary username and an associated pair of temporary keys. The temporary keys can include a temporary public key and a temporary private key that can decrypt the data encrypted using the temporary public key. The client device can use the temporary username and the temporary public key for creating the SSH tunnel with the license management server. After the SSH tunnel is created between the license management server and the client device, the license management server also creates another internal SSH tunnel between the license management server and the license server that contains the license, and connects the internal SSH tunnel to the SSH tunnel. The license is then transmitted to the client device from the license server over the connected tunnel.

In some embodiments, the license management server can revoke access to the license for the user by removing the SSH tunnel between the client device and the license management server and deleting the temporary set of credentials.

### BRIEF DESCRIPTION OF THE DRAWINGS

FIG. 1 is an environment where a license management server can be implemented.

FIG. 2 is a block diagram illustrating a system where a license management server can be implemented, consistent with various embodiments of the disclosed technology.

FIG. 3 is a block diagram illustrating a license management server, consistent with various embodiments of the disclosed technology.

FIG. 4 is a flow diagram a process for obtaining a license using a license management server, consistent with various embodiments of the disclosed technology.

FIG. 5 is a flow diagram of a process for obtaining a license using a license management server, consistent with various embodiments of the disclosed technology.

FIG. 6 is a block diagram of a computer system as may be used to implement features of some embodiments of the disclosed technology.

### DETAILED DESCRIPTION

Technology is disclosed for managing provision of licenses in an unsecure communication network (“the technology”). Various embodiments of the technology include creating a secure environment to serve license requests from users in an unsecure environment such as Internet. One such embodiment includes a license management server that creates a secure communication tunnel, such as secure shell (SSH) tunnel, between a client device of a user requesting a license and a license server that contains the license for accessing a particular application. In some embodiments, the client device can communicate with the license management server and/or a license server over a communication network such as Internet.

In some embodiments, the license management server provides an application programming interface (API) for management of licenses. The API can be accessible via an encrypted communication channel such as hypertext transfer protocol secure (HTTPS). The user can use the API to request the license management server to obtain the license. In some embodiments, the license management server performs multiple authentications to ensure that the user requesting the license is authorized to use the license. Upon receiving a request for a license of a particular type from the user, the license management server checks if the user is authorized to use the license, and if the user is authorized, it sends back set of temporary credentials to the client device that specifies how to setup the SSH tunnel that will be used to access the license server.

In some embodiments, the set of temporary credentials can include a temporary username and an associated pair of temporary keys. The temporary keys can include a temporary public key and a temporary private key that can decrypt the data encrypted using the temporary public key. The client device can use the temporary username and the temporary public key for creating the SSH tunnel with the license management server. After the SSH tunnel is created between the license management server and the client device, the license management server also creates another internal SSH tunnel between the license management server and the license server that contains the license, and connects the internal SSH tunnel to the SSH tunnel. The license is then transmitted to the client device from the license server over the connected tunnel.

In some embodiments, the license management server can revoke access to the license for the user by removing the SSH tunnel between the client device and the license management server and deleting the temporary set of credentials.

### Environment

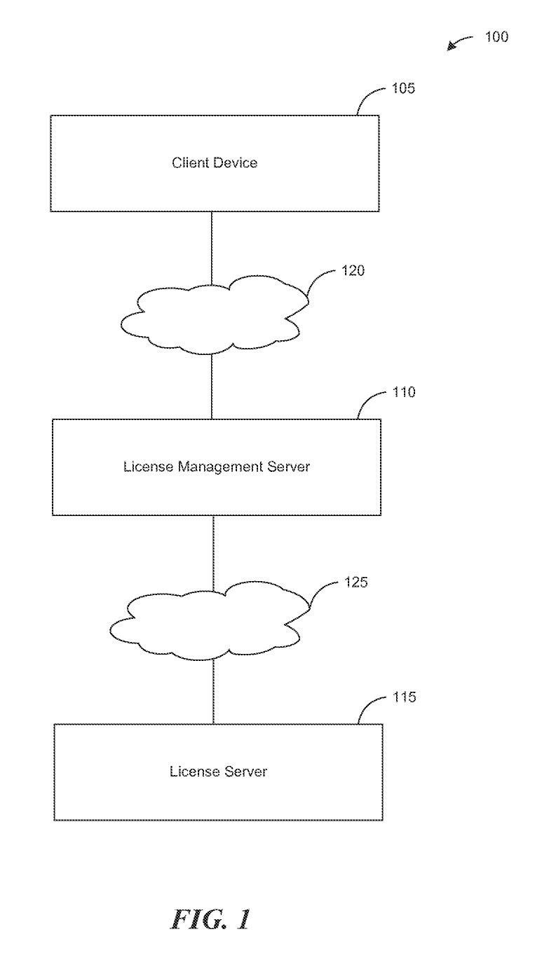

FIG. 1 illustrates an environment where a license management server can be implemented. The environment 100 includes a license management server 110 that manages provision of licenses to users, such as a user associated with client device 105, from a license server 115. In some embodiments, the client device 105 may communicate with the license server 115 via the license management server 110. In various embodiments, the communication between the client device 105 and the license management server 110 can occur over a communication network 120. In various embodiments, the communication between the license management server 110 and the license server 115 can occur over a communication network 125. The communication networks 120 and 125 can be of various types, including a local area network, wide area network and Internet. In some embodiments, the communication network 120 is an unsecured and public communication network such as Internet.

The license management server 110 facilitates a provision of licenses from the license server 115 to the client device 105 over the unsecured communication network 120 in a secure way. In various embodiments, the license management server 110 can use multiple authentication techniques and establish secure communication tunnels between the client device 105 and the license server 115 to manage provision of licenses to the client device 105. The secure communication tunnels can be established using secure communication protocols such as SSH. In some embodiments, SSH is a cryptographic network protocol for secure data communication, remote command-line login, remote command execution, and other secure network services between two networked computers that connects, via a secure channel over an insecure network, a server and a client (running SSH server and SSH client programs, respectively).

The secure communication tunnels can prevent an unauthorized user from breaching into the license server 115 and obtaining a license. In some embodiments, the disclosed technology provides an effective way to revoke a license granted to the client device 105. For example, a license granted to the client device 105 can be revoked by removing the secure communication tunnel between the client device 105 and the license management server 105.

The client device 105 can include devices such as a smart phone, a digital media player, a laptop, a desktop, a tablet PC etc. The licenses can be for various electronic data. For example, a license can be granted for using applications such as animation software tools, e.g., Maya, Arnold. In another example, a license can be granted for listening to music, watching video, downloading files, downloading images, etc. The licenses can be of various types, e.g., a license for single use, for a certain period, to buy, to rent, etc.

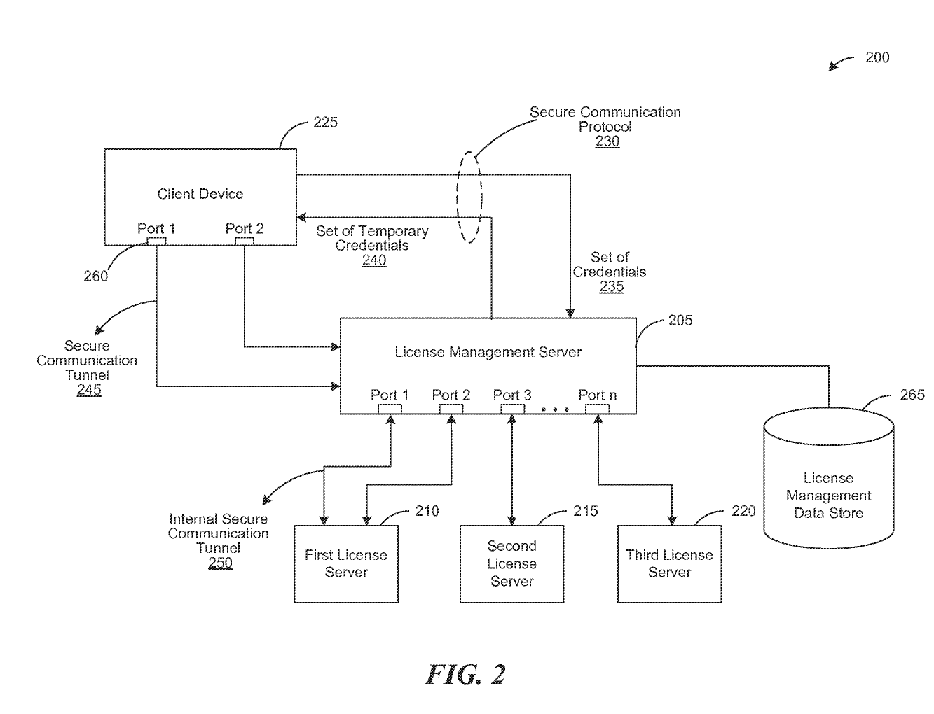

FIG. 2 is a block diagram illustrating a system where a license management server can be implemented, consistent with various embodiments of the disclosed technology. In some embodiments, the system 200 can be implemented in an environment 100 of FIG. 1. The system 200 includes a license management server 205 that manages provision of licenses to users, such as a user associated with client device 225 (hereinafter “client device 225” and “user 225” are used interchangeably), from various license servers, including a first license server 210, a second license server 215 and a third license server 220. In some embodiments, the license management server 205 can be similar to license management server 110, the license servers 210-220 can be similar to license server 115 and the client device 225 can be similar to the client device 105.

In some embodiments, the license servers 210-220 can grant various types of licenses. Further, the license servers 210-220 can be located in various geographical locations. The license servers 210-220 can be identified using identifying data such as Internet Protocol (IP) address or Uniform Resource Locator (URL). In some embodiments, the client device 225 communicates with the license servers 210-220 via the license management server 205. In various embodiments, the communication between one or more of the license management server 205, client device 225 and the license servers 210-220 can occur over a communication network, including an unsecured communication network such as Internet.

The license management server 205 facilitates a provision of licenses from the license servers 210-220 to the client device 225 in a secure way. In various embodiments, the license management server 205 can use multiple authentication techniques and secure communication protocols to grant licenses to users, such as user 225, over an unsecured communication network.

The user 225 requests the license management server 205 to obtain a license, e.g., for accessing an application on the client device 225. The user 225 can send the request to the license management server 205 using various secure communication protocols, including HTTPS. When the license management server 205 receives the request from the user 225, the license management server 205 determines whether the user 225 is authorized to use the license. The license management server 205 can use various authentication techniques to determine whether the user is authorized to use the license. For example, the license management server 205 can use a set of credentials 235 provided with the request to determine whether the user 225 is authorized to use the license. The set of credentials 235 can include a username and a password associated with a user account of the user at a license server. In some embodiments, the license management server 205 may check a license management data store 265 to determine whether the set of credentials 235 provided by the user 225 matches with the set of credentials stored at the license management data store 265.

The license management data store 265 can include various data necessary for administration of the licenses by the license management server 205. The license management data store can be implemented as a database, a file, or any other suitable container for data.

If the license management server 205 determines that the user 225 is authorized to use the license, the license management server 205 generates a set of temporary credentials 240 for the user 225 that can be used by the user 225 in setting up a secure communication tunnel 245 that can be used to access a license server, e.g., first license server 210, that contains the requested license. The license management server 205 associates the temporary username with the temporary public and private keys and stores them as part of license management data at the license management data store 265. The license management server 205 also associates the temporary username with access data of the first license server 210 that contains the license for using the application and stores the association as part of the license management data. In some embodiments, the access data can include one or more of an IP address, URL, etc. of the first license server 210.

The license management server 205 can identify a particular license server among the servers 210-220 as the license server which issues the license to the user 225 based on various factors. For example, the license management server 205 can use information from the request, such as a name of the application for which the license is required, to identify a set of license servers that can grant the license. If more than one license server is identified, the license management server 205 can select one of the license servers based on one or more factors including a proximity of the license server to the user, a load on a license server (e.g. resource utilization) which is below a threshold, user preferences, etc.

After generating the set of temporary credentials 240, the license management server 205 transmits the set of temporary credentials 240 to the user 225 using a secure communication protocol, e.g., using the secure communication protocol with which the user 225 sent the request. In some embodiments, the set of temporary credentials 240 can include a temporary username and a pair of associated keys—a temporary public key and a temporary private key that is used to decrypt data encrypted using the temporary public key. In some embodiments, the license management server 205 can encrypt the whole or part of the set of temporary credentials 240 using the temporary public key.

The client device 225 receives and uses the set of temporary credentials 240 to set up a secure communication tunnel 245 between the client device 225 and the license management server 205. Upon receiving a connection request from the user 225, the license management server 205 determines whether a public key and a username included in the connection request matches with the temporary public key and the temporary username associated with the user 225. In some embodiments, the license management server 205 performs the determination by checking whether the public key and the username included in the request matches with the temporary public key and the temporary username stored at the license management data store 265 for the user 225.

If the license management server 205 identifies the set of temporary credentials 240, the license management server 205 creates a secure communication tunnel 245 on a pre-determined port of the client device 225. In some embodiments, the secure communication tunnel can include a SSH tunnel which is a communication tunnel implemented using a secure communication protocol such as SSH. Further, the license management server 205 also creates an internal secure communication tunnel 250, which can also be a SSH communication tunnel, that connects the license management server 205 with the first license server 210. In some embodiments, the internal secure communication tunnel 250 can be created at a particular port on the first license server 210. In some embodiments, the license management server 205 identifies the first license server 210 to which the internal secure communication tunnel 250 should be created based on the access data of a license server associated with the user 225, which is stored at the license management data store 265.

After creating the internal secure communication tunnel 250, the license management server 205 connects the internal secure communication tunnel 250 with the secure communication tunnel 245 for providing the user 225 access to the first license server 210. In some embodiments, connecting the secure communication tunnel 245 with the internal secure communication tunnel 250 includes forwarding data/messages/requests received from the user 225 via the secure communication tunnel 245 to the internal secure communication tunnel 250 and vice versa. The license management server 205 can use data forwarding tables, e.g., IP table, that can indicate to where the data/messages/requests received at the license management server 205 should be forwarded. The data forwarding tables can be stored at the license management data store 265. In some embodiments, the IP table can have an entry that indicates data/messages/requests received from a particular port should be forwarded to a particular license server and at a particular port. For example, referring to FIG. 2, the IP table can have entry indicating that a request received at the license management server from port 260 should be transmitted to the first license server 210 at a particular port.

After the secure communication tunnels 245 and 250 are set up and connected, the application which the user 225 intends to access generates a request for obtaining the license at the pre-determined port, e.g., port 260 on the client device 225. The request is received at the license management server 205 over the secure communication tunnel 245 which is forwarded to the first license server 210 over the internal secure communication tunnel 250. The first license server 210 then transmits the license to the user 225 via the license management server 205 over the secure communication tunnels 245 and 250.

Referring back to the user 225 generating the request at port 260, in some embodiments, different applications generate requests on different ports. For example, a second application on the client device 225, may be asked to set up the secure communication tunnel on a different port, e.g., “Port 2” on the client device 225. Further, the license management server 205 receives the requests from the user 225 at a port on which SSH is listening on the license management server 205.

In some embodiments, the user 225 may have to be online (remain connected) with the first license server 210 as long as the user 225 intends to access the application. That is, the secure communication tunnels 245 and 250 should be active as long as the user 225 intends to access the application. The user 225 may lose access to the license if the secure communication tunnels are disconnected or removed.

The disclosed technology enables administration of licenses, including provisioning, in an unsecured communication network using secure communication protocols. Further, the disclosed technology also provides convenient ways to revoke access to the license for a particular user. For example, to revoke access for the user 225, the license management server 205 can remove the secure communication tunnels 245 and 250 and delete the set of temporary credentials 240 generated for the user 225. Once the set of temporary credentials 240 are deleted, the request from the user 225 is not identified by the license management server 205 anymore and therefore, access to the license to use the particular application is denied.

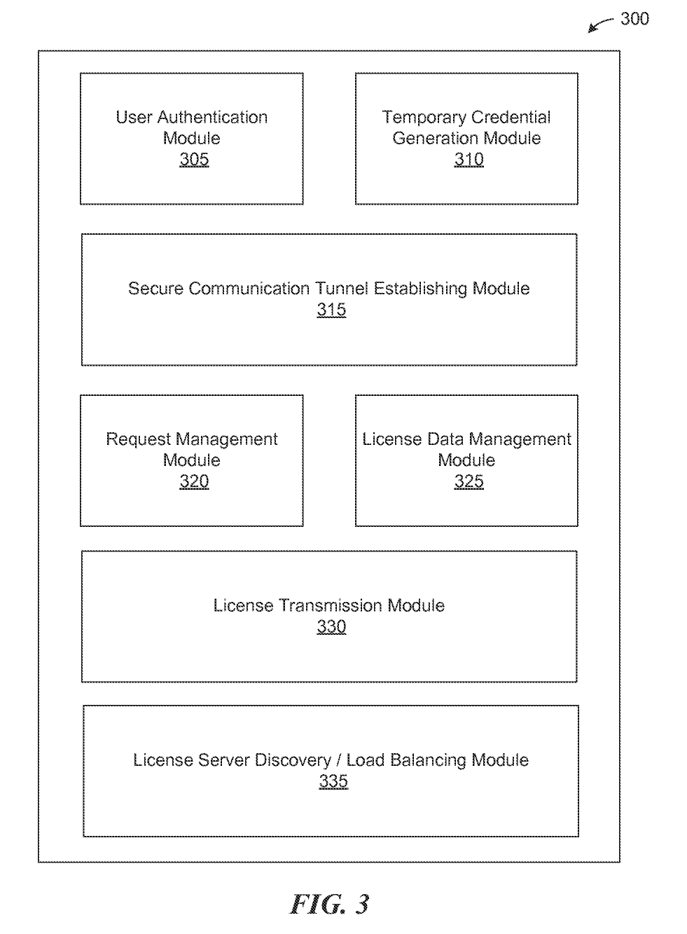

FIG. 3 is a block diagram illustrating a license management server 300, consistent with various embodiments of the disclosed technology. In some embodiments, the license management server 300 can be similar to the license management server 205 of FIG. 2 and can be implemented in the system 200. The license management server 300 includes a user authentication module 305 that can perform authentication of the user, such as user 225. The user authentication module 305 can authenticate the user 225 based on the set of credentials 235 and/or set of temporary credentials 240. The user authentication module 305 can use various authentication techniques to determine whether the user is authorized to use the license. For example, the set of credentials 235 can have one or more of a username and a password associated with a user account at a license server, an IP address of the user 225, a license key of the license to access the application, which was provided to user via one or more means, including email, mail, text message etc. The user authentication module 305 can use the information in the set of credentials 235 to determine whether the user 225 is authorized use the license.

In some embodiments, the user authentication module 305 may verify the information provided in the set of credentials 235 with the information stored in the license management data store 265 to determine whether the user 225 is authorized to use the license.

The license management server 300 includes a temporary credential generation module 310 that generates a set of temporary credentials, such as set of temporary credentials 240, for the user 225 that is used by the user 225 to set up a secure communication tunnel with the license management server 300 to obtain the requested license from a license server. In some embodiments, the set of temporary credentials can include a temporary username and a pair of associated keys—a temporary public key and a temporary private key that is used to decrypt data encrypted using the temporary public key. In some embodiments, the set of temporary credentials 240 is valid for as long as the user 225 is using the license, that is, accessing the application. The set of temporary credentials are deleted if the user stops using the license, e.g., when the application is terminated or closed, the secure communication tunnel 245 is removed etc.

A secure communication tunnel establishing module 315 can establish a secure communication tunnel between the user and the license management server, e.g., the secure communication tunnel 245, and between the license management server and the license server which contains the license requested by the user, e.g., the secure communication tunnel 250, to transmit the license to the user in a secure way. The secure communication tunnel establishing module 315 can implement the secure communication tunnel using various secure communication protocols, including SSH. In some embodiments, the secure communication tunnel establishing module 315 generates the secure communication tunnel at a particular predetermined port on the client device 225 and at a particular predetermined port on the license server.

A request management module 320 can instruct the client device 225 to generate a request for obtaining the license on the predetermined port of the client device 225. The request management module 320 receives the request over a secure communication tunnel, e.g., secure communication tunnel 245 and transmits the request to the license server over a secure communication tunnel, e.g., internal secure communication tunnel 250. In some embodiments, the request management module 320 receives the request at a particular port on the license management server 300, e.g., at a port on which SSH is listening.

A license transmission module 330 obtains the requested license from the license server having the requested license and transmits the license to the user 225 over the secure communication tunnel, e.g., secure communication tunnels 245 and 250.

A license data management module 325 can manage license management data at a data container such as license management data store 265. The license management data can include information such as (a) user account information for accessing a license server, e.g., username and password; (b) set of temporary credentials generated for the user; (c) data forwarding tables, e.g., IP tables, that can be used to forward the requests from the user to the appropriate license server; (d) address details of the license servers, etc. Managing the license management data include inserting, updating, deleting or retrieving license management data from the license management data store 265. The license data management module 325 can ensure that the license management data at the license management data store 265 is current, correct and/or valid.

One or more the modules 305-320 and 330 work with the license data management module 325 to perform their functions. For example, the user authentication module 305 can use the license data management module 325 to obtain user credentials from the license management data store 265 which are used for performing user authentication. In another example, the request management module 320 can use the license data management module 325 to obtain data forwarding information, e.g., IP tables, from the license management data store 265 which are used, e.g., for forwarding the license requests form the user to an appropriate license server.

The license management server 300 can also include a license server discovery/load balancing module 335 that can perform operations including (a) finding an appropriate license server that can provide the license requested by a user and (b) balancing a load between various license servers such as the first license server 210, the second license server 215 and the third license server 220. In some embodiments, the license server discovery/load balancing module 335 can find an appropriate license server which can serve the request, that is, issue the license to the user, based on factors including (a) a type of the license requested, (b) a geographical proximity of a particular license server with the user, (c) a load (e.g., resource utilization) of a particular server, (d) user preferences, e.g., for a particular server, etc. In some embodiments, the license server discovery/load balancing module 335 balances the load on the license servers by distributing the requests to different license servers such that the load on any of the license servers does not exceed a threshold. In some embodiments, the license server discovery/load balancing module 335 can use various known algorithms in finding a best license server among various known license servers based on the above set of factors, and in balancing the load between the license servers.

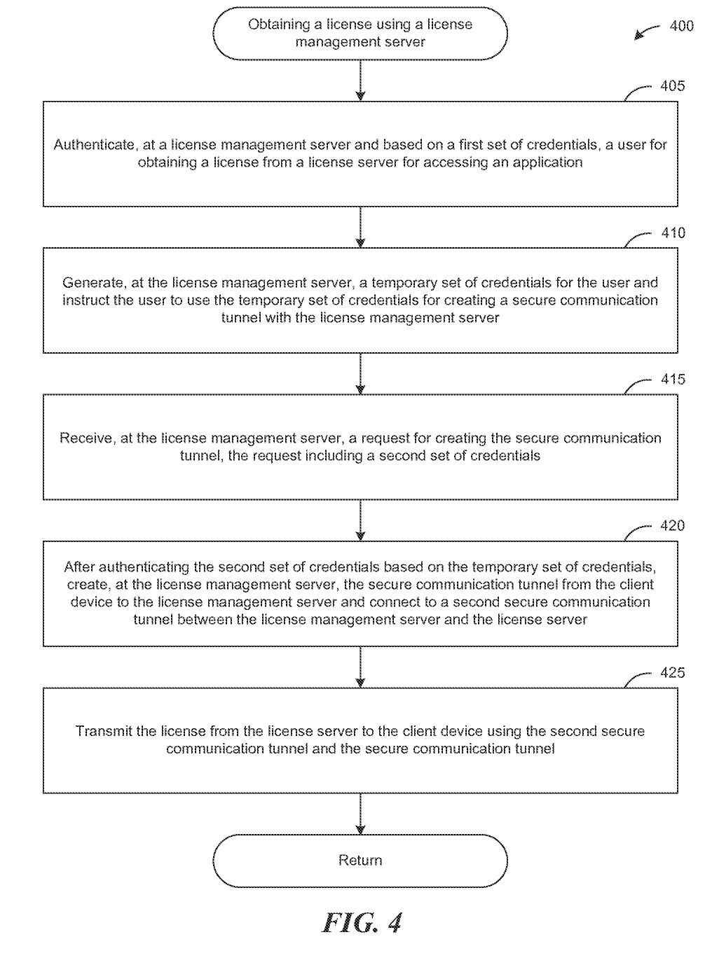

FIG. 4 is a flow diagram a process 400 for obtaining a license using a license management server, consistent with various embodiments of the disclosed technology. The process 400 may be executed in a system such as system 200 of FIG. 2. Upon receiving a request form a user for obtaining a license to use an application, at step 405, the license managing server 205 authenticates the user based on a first set of credentials. The license management server 205 can authenticate the user using various techniques and various parameters. In some embodiments, the license management server 205 may authenticate the user based on a username and a password provided with the first set of credentials. The username and password can correspond to that of a user account associated with the user created at the license management server 205 and/or one or more license servers.

After the user is authenticated, at step 410, the license management server 205 generates a temporary set of credentials for the user and instructs the user to use the temporary set of credentials for creating a secure communication tunnel with the license managing server. In some embodiments, the secure communication tunnel can include a SSH tunnel. In some embodiments, the set of temporary credentials can include a temporary username and a pair of associated keys—a temporary public key and a temporary private key. In some embodiments, the set of temporary credentials is valid for as long as the user is using the license, that is, accessing the application and hence referred to as “set of temporary credentials.” The set of temporary credentials are deleted if the user stops using the license, e.g., when the application is terminated or closed, the secure communication tunnel is removed etc.

At step 415, the license management server 205 receives a request for creating the secure communication tunnel. In some embodiments, the request can include a second set of credentials.

At step 420, if the license management server 205 identifies the second set of credentials based on the temporary set of credentials created by the license management server 205, the license management server 205 creates the secure communication tunnel from the client device 225 to the license management server 205. Further, the license management server 205 connects the secure communication tunnel to a second secure communication tunnel between the license management server 205 and a license server that contains the license for using the application.

At step 425, the license management server 205 obtains the license from the license server and transmits the license to the client device over the secure communication tunnels created for the user 225, e.g., the secure communication tunnel and the second secure communication tunnel.

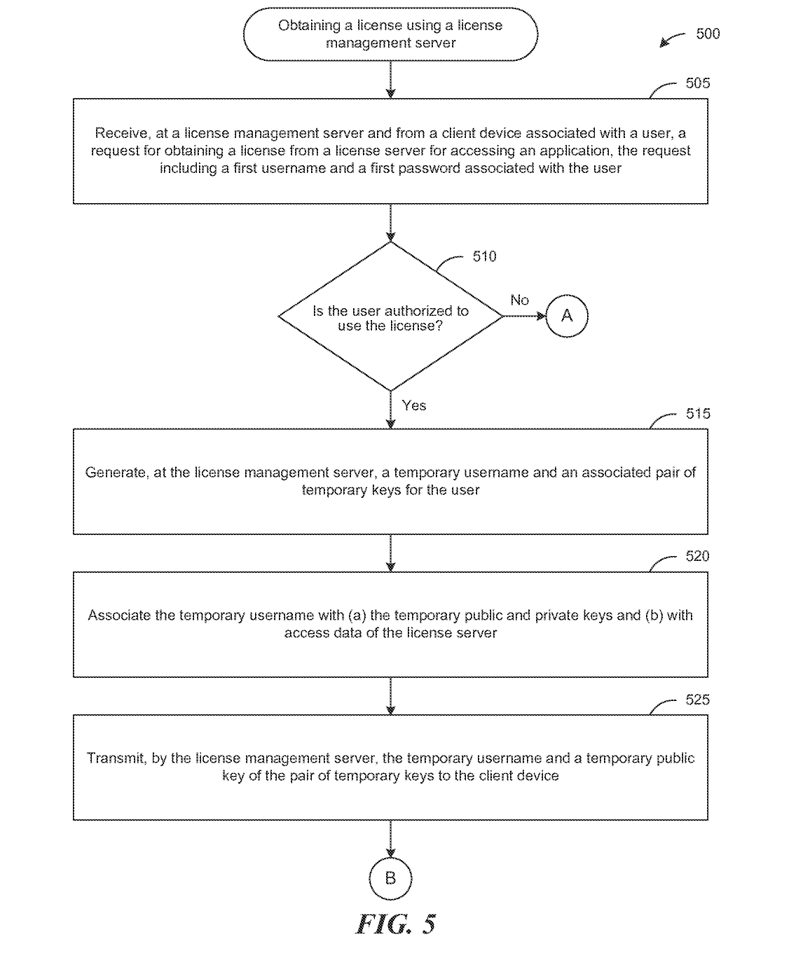

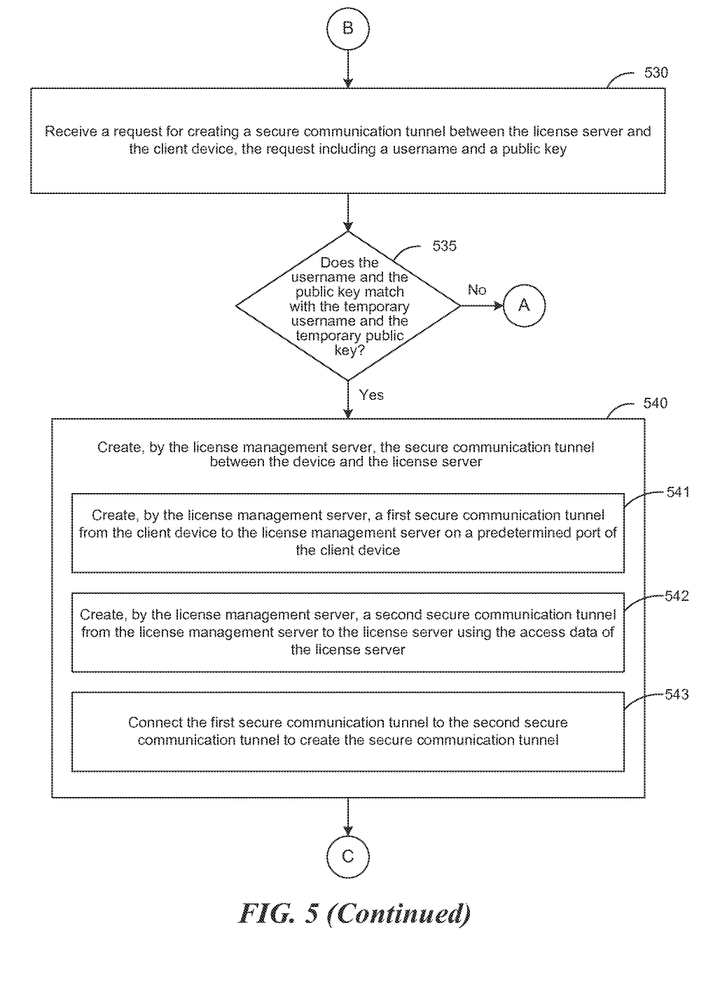

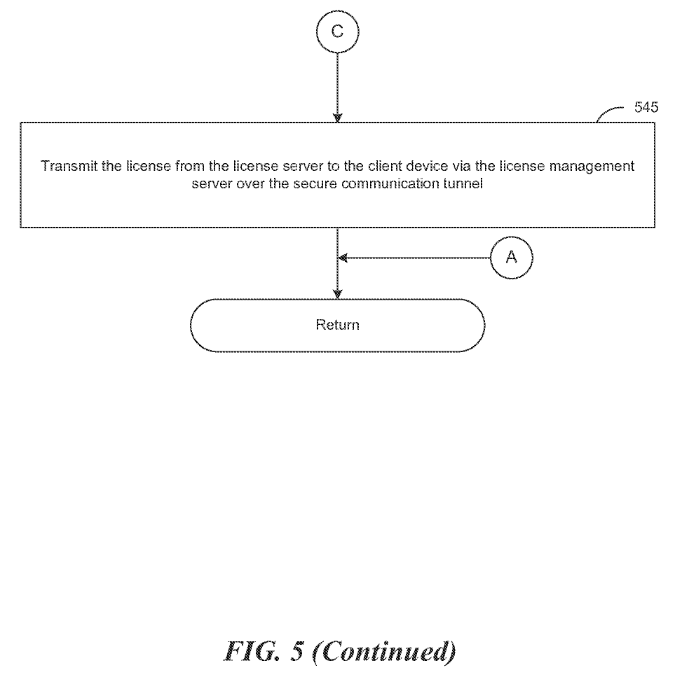

FIG. 5 is a flow diagram of a process 500 for obtaining a license using a license management server, consistent with various embodiments of the disclosed technology. The process 500 may be executed in a system such as system 200 of FIG. 2 and using the license management server 300 of FIG. 3. At step 505, a request management module 320 of the license management server 300 receives a request from a client device associated with a user for obtaining a license from a license server for accessing an application. The request can include a username and a password associated with a user account of the user that may be needed for accessing the license. The client device 225 can request the license management server 300 using an API published by the license management server 300. In some embodiments, the API is accessible using secure communication protocols, including HTTPS. Accordingly, the client device 225 can send the request using HTTPS.

At decision step 510, the user authentication module 305 determines whether the user is authorized to use the license. Responsive to a determination that the user is not authorized to use the license, the process 500 returns. On the other hand, responsive to a determination that the user is authorized to use the license, at step 515, the temporary credential generation module 310 generates a temporary username and an associated pair of temporary keys for the user. In some embodiments, the temporary keys can include a temporary public key and a temporary private key. In some embodiments, the user 225 uses the temporary username and the temporary public key to set up a secure communication tunnel with the license management server 300 for further obtaining access to the license server.

At step 520, the license data management module 325 associates the temporary username with the temporary public and private keys and stores the association in the license management data store 265. Further, the license data management module 325 associates the temporary username with access data of the license server. The access data can include details, e.g., IP address, URL, etc., for accessing a license server that can serve the license server to the user.

At step 525, the temporary credential generation module 310 transmits the temporary username and the temporary public key to the client device. In some embodiments, the temporary credential generation module 310 transmits the temporary username and the temporary public key using the same secure communication protocol, e.g., HTTPS, the client device 225 used to send the request.

At step 530, the request management module 320 receives a connection request for creating a secure communication tunnel between the license server and the client device. In some embodiments, the connection request can include a username and a public key.

At decision step 535, the user authentication module 305 determines whether the username and the public key match with the temporary username and the temporary public key associated with the user which is stored at the license management data store 265. In some embodiments, the user authentication module 305 can use the temporary private key stored at the license management data store 265 to identify whether the public key matches with the temporary public key.

Responsive to a determination that the username and the public key are identified by the user authentication module 305, at step 540, the secure communication tunnel establishing module 315 creates the secure communication tunnel between the client device and the license server. In some embodiments, to create the secure communication tunnel between the client device and the license server, the secure communication tunnel establishing module 315 can perform operations including (a) creating a first secure communication tunnel from the client device to the license management server on a predetermined port of the client device (step 541), (b) creating a second secure communication tunnel from the license management server to the license server using the access data of the license server (step 542), and (c) connecting the first secure communication tunnel to the second secure communication tunnel to create the secure communication tunnel (step 543).

After the secure communication tunnel is set up between the client device and the license server, the request for obtaining the license is transmitted from the client device to the license server over the secure communication tunnel. At step 545, the license transmission module 330 obtains the license from the license server and transmits the license to the client device over the secure communication tunnel.

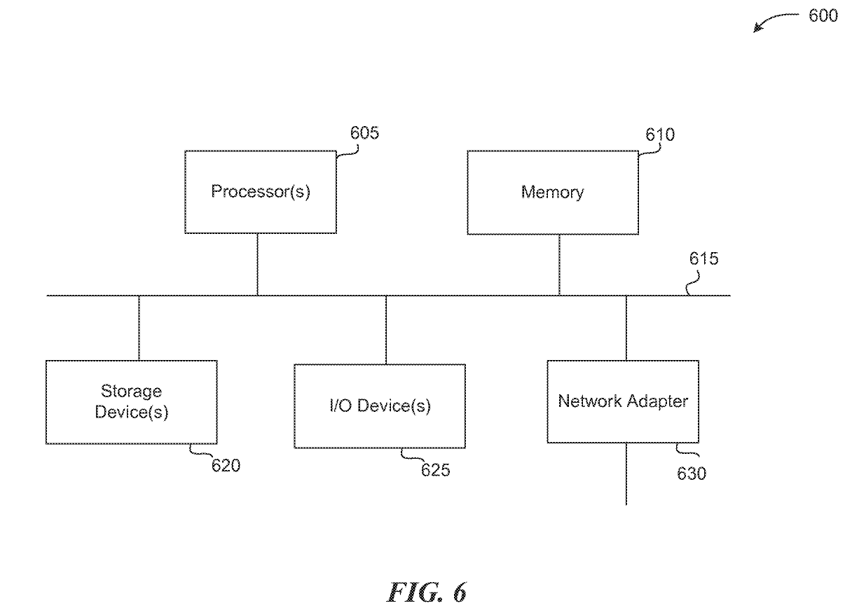

FIG. 6 is a block diagram of a computer system as may be used to implement features of some embodiments of the disclosed technology. The computing system 600 may be used to implement any of the entities, components or services depicted in the examples of FIGS. 1-5 (and any other components described in this specification). The computing system 600 may include one or more central processing units (“processors”) 605, memory 610, input/output devices 625 (e.g., keyboard and pointing devices, display devices), storage devices 620 (e.g., disk drives), and network adapters 630 (e.g., network interfaces) that are connected to an interconnect 615. The interconnect 615 is illustrated as an abstraction that represents any one or more separate physical buses, point to point connections, or both connected by appropriate bridges, adapters, or controllers. The interconnect 615, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 610 and storage devices 620 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 610 can be implemented as software and/or firmware to program the processor(s) 605 to carry out actions described above. In some embodiments, such software or firmware may be initially provided to the processing system 600 by downloading it from a remote system through the computing system 600 (e.g., via network adapter 630).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A method comprising:
receiving, at a license management server of a computing system and from a client device associated with a user, a request for obtaining a license for accessing an application, the request including a first username and a first password associated with the user;
determining, by the license management server and based on the first username and the first password, whether the user is authorized to use the license;
responsive to a determination that the user is authorized to use the license, generating a temporary username and an associated pair of temporary keys for the user;
transmitting, by the license management server, the temporary username and a temporary public key of the pair of temporary keys to the client device; and
creating, by the license management server, a secure communication tunnel between the client device and a license server in the computing system that contains the license based on the temporary username and the temporary public key.

2. The method of claim 1 further comprising:
transmitting, by the license server and via the license management server, the license to the user over the secure communication tunnel.

3. The method of claim 2, wherein the license to use the application is revoked for the user by removing the secure communication tunnel and deleting the temporary username.

4. The method of claim 1, wherein the secure communication tunnel includes an encrypted communication tunnel based on a secure shell (SSH) protocol.

5. The method of claim 1, wherein generating a temporary username and an associated pair of temporary keys for the user further includes:
associating, at the license management server, the temporary username with access data of the license server that includes credentials for accessing the application.

6. The method of claim 5, wherein the access data includes an address and port of the license server and a port for the client device of the user.

7. The method of claim 5, wherein creating a secure communication tunnel between the client device and a license server based on the temporary username and the temporary public key:
receiving a connection request from the client device for creating the secure communication tunnel,
determining, by the license management server, whether a second username and a second public key included with the request matches with the temporary username and the temporary public key, respectively, generated by the license management server, and
responsive to a determination that the second username and the second public key match with the temporary username and the temporary public key, creating, by the license management server, the secure communication tunnel from the client device to the license management server on a predetermined port of the client device.

8. The method of claim 7 further comprising:
creating, by the license management server, a second secure communication tunnel from the license management server to the license server using the access data of the license server, and
connecting the secure communication tunnel to the second secure communication tunnel.

9. The method of claim 8, further comprising:
causing, by the license management server, the client device to forward the request for using the license to the license management server via the predetermined port over the secure communication tunnel,
forwarding, by the license management server, the request to the license server over the second secure communication tunnel connected to the secure communication tunnel.

10. The method of claim 1, wherein the application includes animation software.

11. A method comprising:
generating, at a license management server of a computing system, a temporary set of credentials for a user authorized to use a license for accessing an application, the temporary set of credentials for use by a client device associated with the user for connecting to a license server of the computing system having the license;
establishing, by the license management server and using the temporary set of credentials, a secure communication tunnel from the client device to the license server; and
transmitting, by the license server and via the license management server, the license to the user over the secure communication tunnel.

12. The method of claim 11, wherein generating a temporary set of credentials for a user authorized to use a license for accessing an application includes
determining, at the license management server and based on a first set of credentials of the user, whether the user is authorized to use the license.

13. The method of claim 11, wherein generating a temporary set of credentials for a user authorized to use a license for accessing an application further includes
transmitting, by the license management server, the temporary set of credentials to the client device.

14. The method of claim 13, wherein the temporary set of credentials is transmitted using a secure communication protocol.

15. The method of claim 13, wherein the temporary set of credentials includes a temporary username and a temporary public key, the temporary username and the temporary public key valid as long as the secure communication tunnel exists.

16. The method of claim 11, wherein establishing the secure communication tunnel from the client device to the license server includes responsive to a determination that a set of credentials included with a connection
request from the client device matches with the temporary set of credentials,
creating, by the license management server, the secure communication tunnel from the client device to the license management server on a predetermined port of the client device, and
connecting, by the license management server, the secure communication tunnel to a second secure communication tunnel from the license management server to the license server created using access data of the license server.

17. The method of claim 16, wherein transmitting the license to the user includes
causing, by the license management server, the client device to forward a request for using the license to the license management server via the predetermined port over the secure communication tunnel, and
forwarding, by the license management server, the request to the license server over the second secure communication tunnel connected to the secure communication tunnel.

18. The method of claim 11, wherein the secure communication tunnel includes an encrypted communication tunnel based on a secure shell (SSH) protocol.

19. A system comprising:
a processor;
a temporary credential generation module that works in co-operation with the processor to generate a temporary set of credentials for a user authorized to use a license for accessing an application, the temporary set of credentials for use by a client device associated with the user for connecting to a license server having the license;
a secure communication tunnel establishing module to establish, using the temporary set of credentials, a secure communication tunnel from the client device to the license server; and
a license transmission module to obtain the license from the license server and transmit the license to the user over the secure communication tunnel.

20. The system of claim 19 further comprising:
a request management module that causes the client device to generate a request for obtaining the license on a predetermined port of the client device and transmit the request to the license server via the request management module over the secure communication tunnel.
